(19) United States
(12) Patent Application Publication
(10) Pub. No.: US 2006/0233057 A1
(43) Pub. Date: Oct. 19, 2006

(54) Ultraviolet activating system for preventing digital piracy from recording media

(76) Inventor: Richard H. Selinfreund, Terre Haute, IN (US)

Correspondence Address: KELLEY DRYE & WARREN LLP, TWO STAMFORD PLAZA, 281 TRESSER BOULEVARD, STAMFORD, CT, 06901, US

(21) Appl. No.: 11/404,693

(22) Filed: Apr. 14, 2006

Related U.S. Application Data
(60) Provisional application No. 60/672,265, filed on Apr. 18, 2005.
(60) Provisional application No. 60/673,456, filed on Apr. 21, 2005.
(60) Provisional application No. 60/715,071, filed on Sep. 8, 2005.

(51) Int. Cl. H04B 1/20

(52) U.S. Cl. 369/1

(57) ABSTRACT

An optical medium piracy method and system employing a ultraviolet-sensitive state-change material capable of changing state upon activation with a wavelength of ultraviolet between 253+/−25 nm to 365+/−25 nm, the state-change material in association with digital data indicia, wherein when the state-change material is activated to change state by the ultraviolet radiation, the optical medium moves from an unreadable to a readable condition, or from a less readable to more readable condition.

### RELATED APPLICATIONS

This application claims priority to U.S. Provisional Patent Application Nos. 60/672,265 filed Apr. 18, 2005, 60/673,456 filed Apr. 21, 2005, and 60/715,071 filed Sep. 8, 2005. The disclosure of each such application is hereby incorporated by reference in its entirety where appropriate for teachings of additional or alternative details, features, and/or technical background, and priority is asserted from each.

### BACKGROUND OF THE INVENTION

1. Field of the Invention

The present invention generally relates to the protection of transportable media storing information readable by a reader from piracy anywhere along the distribution chain.

2. Description of the Related Art

The development of software and other forms of content data, such as visual and auditory digital data, represents a large investment in time and money. Such content data is generally stored in digital form on a transportable storage medium which is then sold to a purchaser. Unfortunately, with most traditional transportable recording media, extraction of the data from the transportable storage media is possible anywhere in its distribution chain. Furthermore, given the transportability of the recording media, clandestine movement of the media from the distribution chain is generally easy.

Transportable recording media are particularly prone to shoplifting and intra-distribution chain theft. Shoplifting in sales outlets, and thefts in the distribution chain, are significant problems adversely affecting both sellers and consumers. It may be estimated that with respect to shoplifting of all merchandise, retail sellers lose between $10 and $12 billion annually and spend an additional $7 to $10 billion on anti-shoplifting measures, including security devices and personnel to prevent shoplifting. To offset the costs of shoplifting and distribution chain theft, sellers pass these costs on to consumers in the form of higher prices on merchandise. It may be estimated that each household in the United States pays retail sellers approximately $200 per year in increased retail prices for merchandise due to the costs of shoplifting alone.

It is also not uncommon to have losses in the supply chain due to unauthorized removal of products. Some have estimated that the percent of losses in some areas may reach as high as thirty percent.

There have been numerous attempts to curb content data piracy on transportable recording media. In one approach, a serial number is placed in the content data to allow for tracing of unauthorized copies of the serialized content data. The problem with this method is that it requires the task of external enforcement to track down illegal copies and is of relatively little use when the item is not associable with a particular person. Further, hackers of a number of such systems have found it relatively easy to locate and erase the serial numbers.

To deter shoplifting and distribution chain theft, some entities employ electronic article surveillance (EAS) systems that include transponder tags (RFID, etc.) attached to each article of merchandise. With respect to transportable recording media, such transponder tags are typically associated with the packaging surrounding the media. EAS systems further include one or more electronic readers positioned at exits to detect the transponder tags. When an item is purchased, or is removed from the distribution chain in an authorized manner, the transponder tag is disabled or removed from the article and the merchandise may pass by the reader without sounding an alarm. When a person attempts to remove an article without authorization, the reader detects the transponder tag that has not been disabled or removed from the article and sounds the alarm.

As transportable recording media is often small and easily concealed, EAS systems are easily overcome by simply removing the desired recording medium from its packaging, concealing the medium and then concealingly removing the medium. After the media is removed, the data thereon can generally be copied easily. Placing RFID directly on the digital recording medium has been ruled out for several reasons, including the cost of the recording medium, the difficulty in placing the RFID in a manner to provide a read through a package, and the radio frequencies employed by such systems not being approved for in-flight use.

Theft may also occur when the purveyor of merchandise allows customers or distributors to freely return merchandise even in the absence of proof of purchase, if the merchandise being returned is carried by the sales outlet. Some persons purchase merchandise at reduced sale prices, or pilfer such merchandise, and then return the merchandise to the same or another purveyor for exchange or refund, claiming to have paid full price for the merchandise. In respect of digital recording media, a request for a refund may come after the content of the digital recording medium has been downloaded. If the purveyor refunds the full price, the purveyor loses the amount in excess of the purchase price in addition to the cost of processing the returned merchandise.

One particularly useful method for protecting against piracy is to incorporate on the transportable digital recording medium a state-change material in association with one or more digital data indicia, on the medium in a manner such that the read of the digital data indicia is altered when said state-change material is activated, with the state-change being induced at a point in the distribution chain desired, such as at sale, such that the digital recording medium moves from an unreadable or semi-readable state to a fully or more readable state by a digital reader. While such method offers great promise, difficultly is encountered in inducing the state-change due to the package surrounding most digital medium. Such packaging may comprise a polypropylene shell wrapped with a clear film which may, for example, comprise polyethylene, cellophane or a polypropylene film. It is not commercially practicable in many retail settings for the digital recording medium to be removed from its packaging, the state-change induced with respect to the state-change material associated with the medium, and then replacing the medium back into the packaging. There is a need, therefore, for an improved technique of inducing the state-change without requiring the digital medium to be removed from the packaging.

### Definitions

“Digital Datum Indicium”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a data read.

“Digital Reader”: any device capable of detecting and reading digital information that has been recorded on an Digital Recording Medium.

“Digital Recording Medium”: a medium of any geometric shape (not necessarily circular) that is capable of storing information in digital form thereon. Digital recording medium includes, without limitation, CD, DVDs, HD-DVDs, electromagnetic tape and disks, flash drives and Optical Medium. Information stored on the medium may include, without limitation, software programs, software data, audio files and video files.

“Light-Activated State-Change Material”: a State-Change Material that alters a measurable state function upon application of a wavelength, or subwavelength, of light or application of photonic energy to the material.

“Optical Medium”: a medium of any geometric shape (not necessarily circular) that is capable of storing indicia or content that may be read by an optical reader.

“Optical Reader”: a Reader (as defined below) for the reading of Optical Medium.

“Permanent State-Change Material”: a State-Change Material that once activated to change a measurable state function upon application of energy to the material, stays in such state permanently or for a prolonged period of time.

“Rapid State-Change Material”: a State-Change Material that changes upon activation by an activation source in less than 1 minute from a first state to a second state, both states being discernible by a reader.

“Reader”: A device for reading data on a recording medium. By the term “reader” it is meant to include, without limitation, a player. Examples are CD and DVD readers.

“Sound-Activated State-Change Material”: a State-Change Material that alters a measurable property of the material upon application of sound energy to the material.

“State-Change Material”: a material capable of altering a measurable property of the material upon activation of the material by application of energy to the material. By “state-change material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure) upon application of energy to the material.

“Temporary State-Change Material”: a State-Change Material that, once activated to change a measurable property of the material upon application of energy to the material, stays in such state for a period of time less than a year.

“Transient State-Change Material”: a State-Change material that, once activated to change a measurable property of the material spontaneously in a short period of time (minutes or less), loses such change in the measurable property. It includes, without limitation, materials that move from a first state to a second state upon application of energy, and back to the first state without application of energy.

“Transportable Digital Recording Medium”: a relatively small medium capable of being transported by hand from one location to another. It includes, without limitation, an optical disc, a floppy disk, a flash drive.

For the purpose of the rest of the disclosure, it is understood that the terms as defined above are intended, whether such terms are in all initial cap or not.

### SUMMARY OF THE INVENTION

The present invention provides for activation of a piracy protected transportable recording medium readable on a reader by application of an ultraviolet light source emitting at a wavelength of 253+/−25 nm to 365+/−25 nm. In a particular embodiment, there is provided a privacy protected digital recording medium that is readable on a digital reader.

CD and DVD plastic cases may comprise many materials, in particular polypropylene, and come in a variety of colors ranging from clear to black.

In an embodiment of the present invention, there is provided transportable recording media having incorporated thereon an ultraviolet sensitive state-change material in association with the data indicia thereon in a manner such that read of the indicia is hampered when the ultraviolet sensitive state-change material is in a first state but not a second state. In one digital embodiment, the ultraviolet sensitive state-change material is in association with one or more digital data indicia on the medium in a manner such that the read of the digital data indicia is altered when said state-change material is activated by ultraviolet light. The state-change may be induced at a point in the distribution chain desired, such as at sale, such that the recording medium moves from an unreadable or semi-readable state to a fully or more readable state by a digital reader. By application of ultraviolet light, produced for example by a mercury light source, in a range of about 253+/−25 nm to about 365+/−25 nm, one can induce a change in the ultraviolet-sensitive state-change material associated with the digital recording medium without a need to unpackage the medium when such medium is stored in polymeric packaging standardly used to package CD and DVD discs, such as, without limitation, polypropylene and polyethylene. In one aspect of this embodiment, the case is not black, a color which tends to absorb most wavelengths.

Sunlight may not be rich in ultraviolet light in the range of about 253+/−25 nm to about 365+/−25 nm, or a subrange therein. Therefore, designing the medium to be activated to a read or semi-read state with such wavelengths may be advantageous in that it prevents activation by the ambient environment rather than when activation is actually authorized (such as upon or after retail sale).

In an embodiment, the transportable recording medium is protected against theft, or illicitly moving the digital recording medium in and out of the distribution chain, in that the medium is not readable, or fully readable, until the state-change material is activated to the state necessary for such a read. With respect to digital recording medium, one or more of the digital data indicia associated with the state-change material may be non-nominal or special (i.e., nominal in physical structure but associated with a material, milieu, etc. which is not associated with standard data indicia), causing the transportable digital recording medium to be unreadable, or unreadable with respect to certain information. When the state-change material is selected such that when the state-change material is activated, the non-nominal/special indicia associated with the material no longer blocks the read of the digital data on the medium.

### DETAILED DESCRIPTION OF THE INVENTION

The present invention provides for the protection of transportable media storing information from piracy anywhere along the distribution chain by application of an ultraviolet light state-change material to an transportable recording medium in a manner such as to prevent read of the medium until activation of the ultraviolet-sensitive light change material.

Protection may be provided by allowing the data read of the recording medium to be changed at will by application of the ultraviolet energy source from a limited data read to a more full data read. In digital recording medium, the state-change material may be associated with digital data indicia in such a manner that upon change of the state of the material, the data read of one or more associated digital datum indicium is changed. The state-change material may be, among other material types, a temporary state-change material, a transient state-change material, a permanent state-change material, a rapid state-change material, a light-activated state-change material, and/or a sound-activated state change material.

External activation of the state-change material may preferably be by an energy source producing electromagnetic waves in the ultraviolet range, particularly between 253+/−25 nm to about 365+/−25 nm be by any energy source that causes a measurable state change that is readable by a reader and causes the data indicia to which it is associated to change read or read status (e.g., unreadable to readable).

In an embodiment pertaining to a digital recording medium, the read of one or more digital data indicia is changed by activation of the state-change material to a different state (e.g., a change in optical state in respect of an optical recording medium, or a change in electromagnetic state in respect of an electromagnetic recording medium). One or more digital datum indicium may be associated with the state-change material. More than one state-change material may be used, each reactive to the same ultraviolet wavelengths, different ultraviolet wavelengths, or such ultraviolet wavelengths and another energy activation source (such as another wavelength). Such association may be selective, such as the state-change material being associated with only some of the digital data indicia on the digital recording medium, or the state-change material may be associated with the majority, all, or substantially all, of the digital data indicia.

In an embodiment, there is disclosed a method for piracy protection of digital recording medium comprising: obtaining a digital recording medium packaged in a polymeric housing, the digital recording medium comprising a ultraviolet-sensitive state change material in association with digital data indicia indicative of a valid or error read state, the state-change material being associated with the digital data indicia in a manner such that upon activation of the state-change material by ultraviolet wavelengths between 253+/−25 nm to 365+/−25 nm, the associated digital data indicia read by a reader is read as another valid or error state, or another read state, and wherein the change of the digital data state permits more information to be read by a reader from the digital recording medium; and directing ultraviolet radiation at a wavelength of between 253+/−25 nm to 365+/−25 nm through the packaging housing at the digital recording medium.

In another embodiment, there is disclosed the system wherein the polymeric housing package comprises polypropylene.

A read change may be effectuated only with respect to certain indicia based, for example, on physical differences between the indicia (for example, the state-change material being associated with both nominal and non-nominal indicia), differences in the milieu in association with such special indicia (e.g., a compound existing or missing in the area of the special indicia as compared to the digital data indicia of the recording medium as a whole), or selective response to certain wavelength or energy transmissions (e.g., some areas may comprise ultraviolet-sensitive state-change materials that are activated by wavelengths within the 253+/−25 nm-365+/−25 nm range that are distinct from ultraviolet-sensitive state-change materials that are found in other areas). With respect to digital recording medium, the indicia may be pits and/or lands representative of data incorporated onto an optical recording medium, or other digital data indicia such as electromagnetic aberrations on an electromagnetic recording medium.

In a particular digital recording medium embodiment, the state-change material that is associated with a digital datum indicium that is not a nominal digital datum indicium for the recording medium. For example, the digital datum indicium may be a pit and/or land that is not nominal (standard) for the optical disc format. The non-nominal digital data indicia in such embodiment causes, for example by way of the error correction algorithms associated with the medium or by way of software or firmware associated with the medium or reader, the disc to be unreadable in whole or in part. The state-change material associated with such non-nominal digital datum indicium may be selected to cause change in the read of such non-nominal digital datum indicium blocking read (in whole or in part) upon the state change of the state-change material such that the recording medium can be read in whole or in part (e.g. by allowing correction of the data read by the error correction algorithm). The non-nominal digital data indicia may represent or cause an error read or valid read. For example, when the non-nominal digital data indicia represents or causes an error read, the state-change material in association therewith may be chosen to produce a valid read or different error state that is necessary for the read of the optical medium as a whole. Further, for example, when the non-nominal digital datum indicium represents or causes a valid data read, the state-change material may be chosen to cause when activated either another valid state or an error state necessary for the read of the medium in general. The read of the medium as a whole may be under the control of a software program stored on the medium, in the hardware of the reader, in hardware or software associated with the reader, or may be a function of the error correction algorithms associated with the particular medium being read (such as optical disc correction algorithms).

In yet another embodiment, the recording medium is engineered to be unplayable in an initial state, or the amount of digital information readable from the medium by a reader is limited. Activation of the state-change material is necessary for read or full read of the medium.

In a digital recording medium embodiment, there are found unique pits and/or lands in the presence of the optical state-change material that would induce an uncorrectable error state in the read of the medium. When the state-change material is activated by the appropriate energy source, for example, without limitation, such as light or sound, the read of the unique pits or lands may be changed to cause the uncorrectable error state to change to a valid state permitting the medium to be read.

The digital data indicia causing the digital recording medium not to be read might also be a valid state which might provide an ambiguous or non-ambiguous read that because of one or more algorithms associated with the reader or disc prohibits the read of the digital recording medium (or a portion of the digital reading medium). Activation of the state-change material could cause such valid state to convert to another valid state or an error state that is necessary, because of algorithms associated with the reader system or medium or firmware/hardware setup, for the full read of the medium (or portion of the medium). Similarly, although the digital datum indicium may be an error state with read effectuated, owing to such algorithms or firmware/hardware set up, only when another error state or a valid state is produced upon activation of the state-change material.

In one digital data recording medium embodiment, the digital data recording medium comprises digital data indicia that cause an error data read that prohibits the medium from being read, or a portion of the medium to be read. When the recording medium is exposed to the appropriate energy source for converting the state-change material, the data read is changed to a valid state allowing for the reading of the recording medium.

In one embodiment, the state-change material is spin coated or placed over a entire digital recording medium, and the material is selected such that it does not affect the read of nominal digital data indicia, but just special digital data indicia. Different spin coat speeds may be used at points in the spin coating (such as, for example, Application 600 RPM, Dwell at 2000 RPM, and Spin Off 5000 RPM). The special digital data indicia may differ in structure from other digital data indicia (e.g. a pit of different dimensions and/or shape and/or fabrication) on the digital recording medium, or such special digital data indicia may be associated with one or more materials not found in respect of the other digital data indicia, or may be missing one or more materials that are associated with other digital data indicia (i.e., but not the special digital datum indicium). For example, the special digital data indicia may not be associated with an oxidation scavenger that is associated with other digital data indicia associated with the state-change material. Such oxidation scavenger may cause rapid conversion of the state-change material back to its original state, while the lack of such oxidation scavenger may cause the state-change material to stay in the activated state permanently or for significant periods of time. The state-change material may change in a way to allow all of the nominal digital data indicia to be read on the digital medium except for those special digital data indicia (which may be “read-blocking digital data indicia” that is indicia that is blocking read of the medium on a reader) that although they may be of the same structure as other nominal digital data indicia lack one or more materials in their milieu necessary for the appropriate state change in the state-change material or necessary to keep the activated state change for a desired period of time. Thus with respect to special digital data indicia, there may not be the need for engineered sub-structures (non-nominal digital data indicia) on the digital recording medium to effectuate such embodiment of the present disclosure.

The state-change material alternatively (or in combination with spin coating, or placement on one of the surfaces of the recording medium) may be included in the proper of the digital recording medium. For example, a recording dye may be mixed into the polycarbonate pellets that will be used to fabricate the digital recording medium.

The state-change material, such as a quantum dye, could be placed in association with all or substantially all of the digital data indicia on the digital recording medium. The state-change material can be selected such that in association with such indicia that the digital recording medium can not be read, but upon activation the state change allows read of the digital recording medium.

The state-change material may in one embodiment affect, for example, the reflection or refraction in an optical medium.

In one application, the data recording medium is placed into a packaging comprising polypropylene and/or polyethylene, or other materials through which the ultraviolet wavelengths are emitted. The ultraviolet-sensitive state-change material is selected to be sensitive to ultraviolet light in the range of 253+/−25 nm to 365+/−25 nm which pass through the packaging, such as an Amray case, at an anticipated energy level given the selected emission source. Upon activation of the material, the digital data indicia read is changed in a manner (error to valid, valid to valid, valid to error, error to error, readable to unreadable, or vice versa) that is necessary, given software control or error correction algorithms in place to allow for the read of the medium or firmware/hardware set up, in a more robust manner or fully.

By selectively activating at check out with the correct ultraviolet frequencies, the initially unreadable recording medium can become readable when an ultraviolet-sensitive state-change material is employed for the piracy protection. Activation of the state-change material may involve single or multiple ultraviolet wavelengths in the range of 253+/−25 nm to 365+/−25 nm. Activation may, for example, make a disc in the error state, or unreadable state, to a disc in the valid state, or readable state, that plays correctly.

It is generally preferred for retail sale purposes of such digital recording medium that the activation is permanent and non-reversible.

By judicious activation within such ultraviolet wavelength range, the digital recording medium may be designed so as to not be, or to not easily be, activated in sunlight. Selection of the state-change material may take into account minimum activation time (for example, in a retail setting activation may be preferably less than one minute), the cost of the material (which may preferably add little to the overall cost of the product), and its effect on the long term performance of the digital recording medium (which may be minimized unless the medium is desired to degrade in performance at a time frame in the future). Given the emission source, and its energy, one may select the state-change material to allow for activation of multiple/stacked/layered discs at one time.

Manufacturing to retail end point protection may be desired. Activation preferably should be simple and reliable in a retail setting if activation is performed at such a juncture. It may be preferred that the recording medium not be easily reversed engineered (e.g. difficult to reproduce the chemistry of the state-change material, or placement of the same). In one useful retail case, the recording medium is not activated in the supply chain until retail sale, and the activation mechanism at check out may be designed to be difficult to detect or reverse engineer.

When special or non-nominal digital data indicia are employed on the recording medium are employed, as such may be unique, the special or non-nominal digital data indicia may be used for track and tracing, and authentication of a digital recording medium, and therefore may be used in lieu of RFID and other such tags.

The state-change material or the special or non-nominal digital data indicia may be specifically placed. For example, when non-nominal pits are used, they may be placed at the lead area to aid in concentrating and focusing waves to the activation area. The state-change material may be placed during or after the manufacture of the recording medium. For example, the state-change material may be placed over the molded parts before metallization and bonding or may be added to the digital recording medium in the sputter coating during the manufacturing of the digital recording medium.

The recording medium may be, for example, an optical disc (such as CD, DVD, DVD-R, HD-DVD, Blu-Ray), magnetic tape, floppy discs, etc. The recording medium may store data in digital and/or analog form.

Activation may be at any point in the distribution or manufacturing chain, such as at retail sale. Activation may be by ultraviolet radiation in the specified spectrum range before movement to the purchaser, and may further require other activation post distribution such as at home to allow all or some part of the data to be read by the purchaser. For example, further activation may be by way of entering into a website to determine a pass code or other information necessary to activate the digital recording medium. Likewise, activation may be by way of website entered into at any point in the distribution or manufacturing chain, as well as activation by the ultraviolet source.

### EXAMPLE

The UV spectrum of a standard CD plastic case may be taken. A representative plastic case may show weak absorbance at 253.7 nm, 80% at 365.0 nm, and about 50% at 296.7 nm.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. A method for piracy protection of digital recording medium comprising:
obtaining a digital recording medium packaged in a polymeric housing, said digital recording medium comprising a ultraviolet-sensitive state change material in association with digital data indicia indicative of a valid or error read state, said state-change material being associated with said digital data indicia in a manner such that upon activation of the state-change material by ultraviolet wavelengths between 253+/−25 nm to 365+/−25 nm, the associated digital data indicia read by a reader is read as another valid or error state, or another read state, and wherein the change of the digital data state permits more information to be read by a reader from the digital recording medium;
directing ultraviolet radiation at a wavelength of between 253+/−25 nm to 365+/−25 nm through said packaging housing at said digital recording medium.

2. The method of claim 1 wherein the polymeric housing package comprises polypropylene.

3. The method of claim 1 wherein the polymeric housing package comprises polyethylene.

4. The method of claim 2 wherein the polymeric housing package is wrapped in a polymeric film and the ultraviolet radiation is directed through both the polymeric film and the polymeric housing package.

5. The method of claim 4 wherein the polymeric film is selected from one or more of the group consisting of: polyethylene, cellophane, and polypropylene.

6. A system for piracy protection of digital recording medium, said system comprising:
a digital recording medium packaged in a polymeric housing, said digital recording medium comprising a ultraviolet-sensitive state-change material in association with digital data indicia indicative of a valid or error read state, said state-change material being associated with said digital data indicia in a manner such that upon activation of the state-change material by ultraviolet wavelengths between 253+/−25 nm to 365+/−25 nm that the associated digital data indicia read by a reader is read as another valid or error state, or another read state, wherein the change of the digital data state permits more information to be read by a reader of the digital recording medium; and
an ultraviolet radiation emitter emitting a wavelength of between 253+/−25 nm to 365+/−25 nm capable of emitting such waves at the packaged digital recording medium.

7. The system of claim 6 wherein said polymeric housing package comprises polypropylene.

8. The system of claim 6 wherein said polymeric housing package comprises polyethylene.

9. The system of claim 7 wherein said polymeric housing package is wrapped in a polymeric film.

10. The system of claim 9 wherein said polymeric film is selected from one or more of the group consisting of: polyethylene, cellophane, and polypropylene.
